(19) United States
(12) Patent Application Publication
(10) Pub. No.: US 2006/0237259 A1
(43) Pub. Date: Oct. 26, 2006

(54) Method of acoustic damping within electronic device cabinetry

(75) Inventor: Jerry B. Lowe, San Clemente, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Mitsubishi Digital Electronics America, Inc.

(21) Appl. No.: 11/101,929

(22) Filed: Apr. 7, 2005

(51) Int. Cl. B41J 29/08; H02K 5/24

(52) U.S. Cl. 181/202; 181/201

(57) ABSTRACT

Cabinetry for a variety electronic devices that facilitates acoustic attenuation. Although significantly lighter in weight, the structural integrity of the cabinetry tends to be comparable to conventional cabinetry. The cabinetry utilizes expanded polystyrene (EPS) foam to form the basic shell or core with the shape of the desired enclosure. Appropriate coatings are then added to the surface of the EPS shell to ensure durability. The low mass, low modulus of elasticity and high internal damping of the EPS core of the completed enclosure strongly absorbs and, thus, attenuates noise emanating from within the enclosure. The addition of high density coating(s) to the faces of the EPS core provide high weight per unit area material that further blocks the passage of sound through the EPS core.

### FIELD OF THE INVENTION

The present invention relates generally to cabinetry for electronic devices such as televisions (TVs) and other consumer electronic devices and, more particularly, to structural enclosure material that facilitates acoustic damping.

### BACKGROUND OF THE INVENTION

Electronic devices having enclosures formed of wood cabinetry with adequate strength to be serviceable in consumer markets, tend to be very heavy for the size of the electronic device. In addition, wood enclosures require surface treatments to ensure the enclosure's durability in service. In an attempt to reduce the weight of electronic devices, the enclosures of such devices are often made from plastic cabinetry. Plastic enclosures are light weight and reasonably durable but must be made with very thin cross sections to be cost effective in high volume production cabinetry.

Wood cabinetry tends to make relatively good acoustic enclosures because of the large mass per unit area and relatively high acoustic damping associated with the wood fibers. Plastic cabinetry, on the other hand, generally makes poor acoustic enclosures for the opposite reason—i.e., small mass per unit area of the enclosure and poor internal damping of the basic materials.

As electronic devices such as computers, audio-video devices, TVs, and the like, continue to increase and enhance performance capabilities, their power consumption and, thus, heat generation continues to grow. To combat the heat, device manufacturers often install additional fans to sufficiently exhaust heat from the enclosure of such devices. The additional fans increase the noise generated from within the enclosure and the need for greater acoustic damping by the enclosure. To combat the increase in noise and provide greater acoustic damping, some manufacturers attach acoustic material to the interior of the enclosure walls, which adds to the cost and complexity of the manufacture of the electronic devices.

Thus, it would be desirable to provide cabinetry for electronic devices that is lightweight, structurally sound, and acoustically attenuating, and tends not to increase the cost and complexity of manufacture of the electronic devices.

### SUMMARY

In one embodiment, which is described below as an example only and not to limit the invention, cabinetry is provided for a variety electronic devices such as TVs, audio-video devices, and the like, that, when compared to conventional cabinetry, tends to be simpler and less costly to manufacture, lighter in weight, structural sound, and acoustically attenuating. Although significantly lighter in weight, the structural integrity of the cabinetry of these embodiments tends to be comparable to conventional cabinetry. In an exemplary embodiment, the cabinetry utilizes molded plastic foam formed from expanded polystyrene (EPS) foam to form the basic shell with the shape of the desired enclosure. The EPS foam has an expanded density at a level, preferably in a range of about three pounds per cubic feet (3 PCF), at which the panels or enclosures formed there from have sufficient structural strength to form an enclosure and eliminate the need to add structural panel(s) or sheeting to provide or enhance the structural integral of the enclosure.

Appropriate coatings are then added to the surface of the EPS shell to ensure durability and strength against surface damage due to scratches, punctures, cuts and the like. The low mass, low modulus of elasticity and high internal damping of the EPS core of the completed enclosure strongly absorbs and, thus, attenuates noise emanating from within the enclosure. The addition of high density coating(s) to the faces of the EPS shell provide high weight per unit area material that further blocks the passage of sound through the cabinetry walls.

In an alternative embodiment, which is described below as an example only and not to limit the invention, cabinetry panels are first formed from EPS foam and then the surface of the EPS panels are coated with appropriate coatings. The coated EPS panels are then joined to form an enclosure. Like the molded EPS shell, the low mass, low modulus of elasticity and high internal damping of the molded EPS panels of the completed enclosure strongly absorbs and, thus, attenuates noise emanating from within the enclosure. The addition of high density coating(s) to the faces of the EPS panels provide high weight per unit area material that further blocks the passage of sound through the cabinetry walls.

Other aspects and features of the present invention will become apparent from consideration of the following description taken in conjunction with the accompanying drawings.

### BRIEF DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a side view of a projection TV having an enclosure formed of coated EPS cabinetry for increased noise attenuation.

FIG. 2 is a side view of a loud speaker having an enclosure formed of coated EPS cabinetry for increased noise attenuation.

FIG. 3 is a perspective view of an audio-video receiver having an enclosure formed of coated EPS cabinetry for increased noise attenuation.

### DETAILED DESCRIPTION OF PREFERRED EMBODIMENTS

Referring in detail to the figures, the apparatus and methods described herein allow for the efficient attenuation of noise from electronic device enclosures. The illustrated embodiments, which are provided without limitation and for exemplary purposes only, include cabinetry that comprises coated EPS material that, when compared to conventional cabinetry, tends to be simpler and less costly to manufacture, lighter in weight, structural sound, and acoustically attenuating. Although significantly lighter in weight, the structural integrity of the cabinetry of these embodiments tends to be comparable to conventional cabinetry.

In forming the cabinetry, a mold of the desired cabinet, cabinet shell or cabinet component such as a wall panel, is preferably cast from aluminum or other appropriate material. Prior to injecting the polystyrene into the mold at relatively low pressures in the range of about five (5) to fifteen (15) psi and preferably about eight (8) psi, the polystyrene is subjected to a process known by those skilled in the art to inject a blowing agent, such as heptane, into the polystyrene beads. The polystyrene is then injected into the mold and heated to expand the blowing agent within the beads, which in turn expands the beads such that the polystyrene material coalesces into a generally homogeneous structure as it is pressed against the walls of the mold. Preferably, the polystyrene material is injected into the mold with live steam. The steam tends to drive most of the blowing agent out of the beads, which tends to make the end product more flame retardant.

In a preferred embodiment, the polystyrene beads are expanded about twenty (20) times their original size and optionally within a range of about fifteen (15) to thirty (30) times their originally size. The pre-expanded density of the polystyrene beads tends to be in a range of about 60 PCF. When the polystryrene beads are expended and coalesces into a generally homogeneous structure, the EPS structure preferably has a material density in the range of about two to three PCF, and more preferably about three PCF.

Once released from the mold, the cabinet or cabinet component, e.g., a structural panel, is preferably coated with an appropriate high density material such as plastic to provide surface durability and strength to guard against defects due to surface scratches, punctures and cuts. In a preferred embodiment, a urethane material, such as Styrothane™, may be used to provide the cabinet or component with a hard resilient and cosmetically appealing outside surface finish. Alternatively, the exterior of the cabinetry may be coated with a material that is less costly due to its flamability rating.

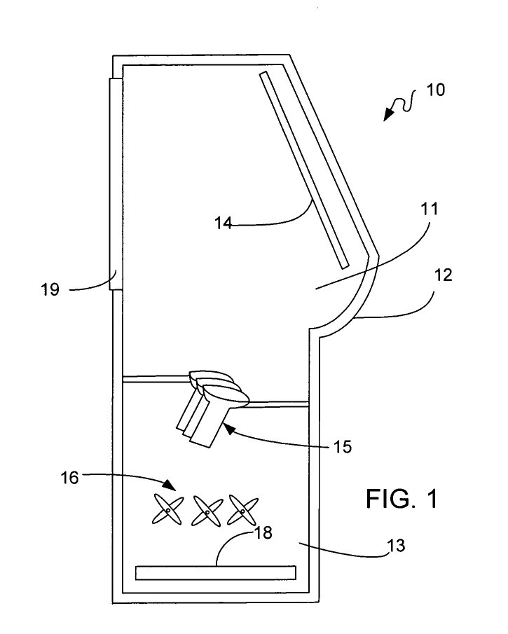

Referring to FIG. 1, a projection TV 10 is shown to include a cabinet 12 housing an optical unit 15 in a lower portion 13 of the cabinet 12 and a mirror 14 in a upper cabinet portion 11. A screen 19 is shown mounted on the cabinet 12. Also located in the lower portion 13 of the cabinet 12 is the electronic circuitry 18 of the TV 10. The electronic circuitry tends to be a high generator of heat that must be exhausted from the cabinet 12 preferably by one or more exhaust fans 16. The exhaust fans 16 can be a significant source of noise emanating from the interior of the cabinet 12.

The cabinet 12 is preferably formed from a molded EPS shell or from molded EPS panels that are assembled or joined to form the cabinet 12. The outer surfaces of the EPS shell or EPS panels are then coated with an appropriate high density material to provide a hard resilient and cosmetically appealing surface.

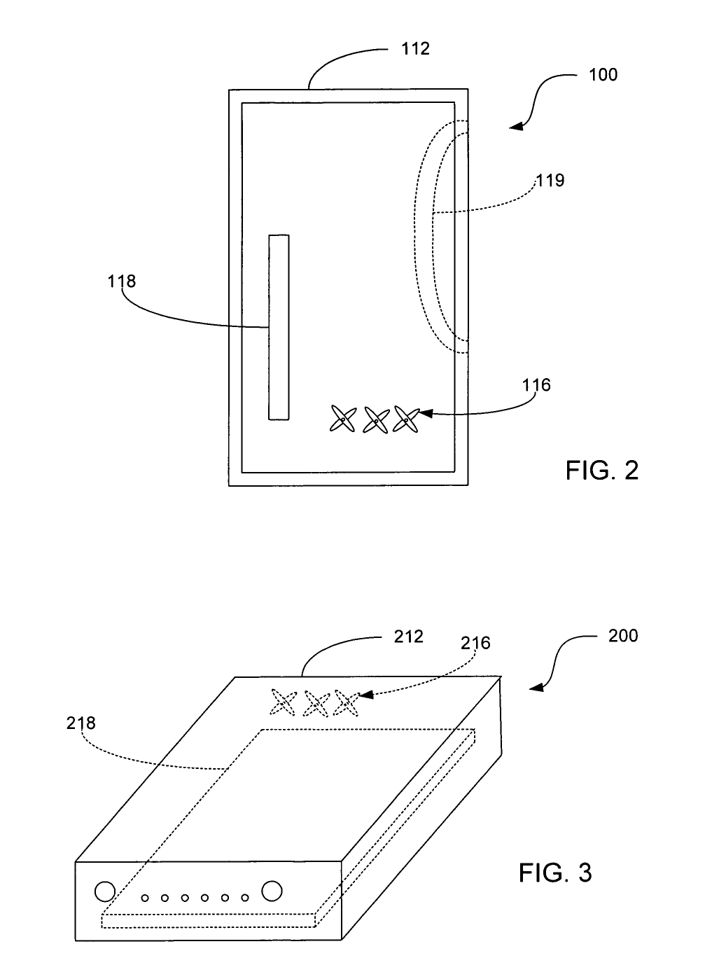

Alternative embodiments, which are shown in FIGS. 2 and 3 without limitation and for exemplary purposes only, include a loudspeaker 100 and an audio-video receiver 200. The loudspeaker includes a cabinet 112, a speaker component 119 mounted therein, and electronic circuitry 118 located within the cabinet. Similarly, the audio-video receiver 200 includes a cabinet 212 and electronic circuitry 218 located therein. The receiver 200 and loud speaker 100 may similarly include one or more exhaust fans 216 and 116 to exhaust heat generated by the electronic circuitry 218 and 118. Like cabinet 12, the cabinets 112 and 212 shown in FIGS. 2 and 3 are preferably formed from a molded EPS shell or from molded EPS panels that are assembled or joined to form the cabinet. The outer surfaces of the EPS shell or EPS panels are then coated with an appropriate high density material to provide a hard resilient and cosmetically appealing surface.

In operation, the low mass, low modulus of elasticity and high internal damping of the molded EPS core of the completed cabinet 12 strongly attenuates or absorbs noise emanating from within the cabinet 12. The additions of high density coating(s) to the faces of the EPS core or panels provide high weight per unit area material to further block the passage of sound through the cabinetry walls. Experiments have shown increased noise attenuation when compared with wood cabinetry and plastic cabinetry.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims. Furthermore, it should also be understood that the features or characteristics of any embodiment described or depicted herein can be combined, mixed or exchanged with any other embodiment.

What is claimed is:

1. A method of reducing noise emanating from the interior of a consumer electronic device, comprising the steps of
absorbing noise emanating from within a consumer electronic device in an expanded polystyrene (EPS) structural panel of a cabinet of the consumer electronic device, and
blocking passage of noise through the EPS structural panel with a coating of material on the outer surface of the EPS structural panel.

2. The method of claim 1 further comprising the step of forming an EPS structural panel with an expanded bulk density in a range of about 2 to 3 pounds per cubic foot.

3. The method of claim 1 further comprising the step of forming an EPS structural panel with an expanded bulk density of about 3 pounds per cubic foot.

4. The method of claim 1 further comprising the step of forming an EPS structural panel from polystyrene beads having an unexpanded bulk density of about 60 pounds per cubic feet.

5. The method of claim 1 further comprising the step of forming the cabinet of the consumer electronic device from EPS structural panels.

6. The method of claim 5 wherein the panels are integrally formed.

7. The method of claim 2 wherein the EPS panel is coated with a high density material.

8. The method of claim 7 wherein the high density material is plastic.

9. The method of claim 7 wherein the high density material is a urethane material.

10. A sound attenuating enclosure for consumer electronic device comprising
an enclosure shell comprising an expanded polystyrene (EPS) core having a low modulus of elasticity and high internal damping, and
a high density coating applied to the surface of the shell to further block passage of sound through the shell.

11. The sound attenuating enclosure of claim 10 wherein the EPS core has an expanded bulk density in a range of about 2 to 3 pounds per cubic feet.

12. The sound attenuating enclosure of claim 10 wherein the EPS core has an expanded bulk density of about 3 pounds per cubic feet.

13. The sound attenuating enclosure of claim 10 wherein the EPS core is formed from polystyrene material having an unexpanded bulk density of about 60 pounds per cubic feet.

14. The sound attenuating enclosure of claim 10 wherein the EPS core comprises a plurality of individual EPS panels coupled together.

15. The sound attenuating enclosure of claim 10 wherein the high density coating comprises a plastic material.

16. The sound attenuating enclosure of claim 10 wherein the high density coating comprises a urethane material.

17. The sound attenuating enclosure of claim 16 wherein the urethane material is Styrothane™.

18. The sound attenuating enclosure of claim 10 wherein the consumer electronic device is a television.

19. The sound attenuating enclosure of claim 10 wherein the consumer electronic device is an audio-video receiver.

20. The sound attenuating enclosure of claim 10 wherein the consumer electronic device is a audio speaker.
